(19) United States
(12) Patent Application Publication
(10) Pub. No.: US 2014/0051409 A1
(43) Pub. Date: Feb. 20, 2014

(54) PILOT SIGNAL STATE PROMPTING METHOD, BASE STATION CONTROLLER, AND MOBILE SWITCHING CENTER

(71) Applicant: Huawei Device Co., Ltd., Shenzhen (CN)

(72) Inventor: Hansong XIAO, Wuhan (CN)

(73) Assignee: Huawei Device Co., Ltd., Shenzhen (CN)

(21) Appl. No.: 14/064,938

(22) Filed: Oct. 28, 2013

Related U.S. Application Data
(63) Continuation of application No. PCT/CN2011/073372, filed on Apr. 27, 2011.

(51) Int. Cl. H04W 24/04; H04W 4/16

(52) U.S. Cl. CPC H04W 24/04; H04W 4/16
USPC 455/414.1

(57) ABSTRACT

Embodiments of the present invention disclose a pilot signal state prompting method, a base station controller, and a mobile switching center, where the method includes: receiving pilot strength reported by a first terminal in a call state; when the pilot strength is smaller than a preset threshold value, sending prompt signaling to a mobile switching center corresponding to a peer end terminal in the call state, and sending, by the mobile switching center corresponding to the peer end terminal, according to the prompt signaling, to the peer end terminal, a prompt message indicating that a pilot signal state of the first terminal is poor. The pilot signal state prompting method disclosed by the embodiment can achieve a purpose that the peer end terminal may timely obtain the pilot signal state of the first terminal and learn a reason why a normal call cannot be performed currently, thereby improving user experience.

### CROSS-REFERENCE TO RELATED APPLICATIONS

This application is a continuation of International Patent Application No. PCT/CN2011/073372, filed on Apr. 27, 2011, which is hereby incorporated by reference in its entirety.

### TECHNICAL FIELD

The present invention relates to the field of a mobile communication device, and in particular, to a pilot signal state prompting method, a base station controller, and a mobile switching center.

### BACKGROUND

In a CDMA (Code Division Multiple Access, code division multiple access) network, after two mobile terminal users A and B establish a call, a simplified model of their network topology structure is as shown in FIG. 1, and includes a base station system BS1 and a mobile switching center MSC1 that correspond to the user A, and a base station system BS2 and a mobile switching center MSC2 that correspond to the user B. A BS is a wireless transceiver device of the CDMA network, and mainly performs wireless communication with a mobile terminal. An MS is responsible for managing traffic of a mobile user.

In a calling state of a terminal user, a terminal reports currently detected pilot strength to a BS. When the terminal user is in a wireless environment with a stronger signal, a reported pilot strength value is higher, and on the contrary, a reported pilot strength value is smaller. As a result, the BS can monitor the pilot strength of the terminal in real time, thereby determining, according to a pilot strength value, signal strength of a wireless environment where the terminal user is located.

The weaker a signal in an environment where the terminal user A is located is, the smaller a value of pilot strength detected by the BS1 is. When the value decreases to a certain extent, the user A may experience an exception, such as an interrupted call and a voiceless call. Because of the exception on the user A, the user B also experiences a call exception. For example, the user B says a lot of words to the user A, but cannot hear any response from the user A, which severely affects communication quality and decreases user experience.

### SUMMARY

In view of this, the present invention provides a pilot signal state prompting method, a base station controller, and a mobile switching center. Specific solutions are as follows:

A pilot signal state prompting method includes:

receiving pilot strength reported by a first terminal in a call state; and

when the pilot strength is smaller than a preset threshold value, sending prompt signaling to a mobile switching center corresponding to a peer end terminal in the call state, and sending, by the mobile switching center corresponding to the peer end terminal, according to the prompt signaling, to the peer end terminal, a prompt message indicating that a pilot signal state of the first terminal is poor.

A pilot signal state prompting method includes:

receiving prompt signaling, where the prompt signaling is sent by a base station controller corresponding to a first terminal to a mobile switching center corresponding to a peer end terminal in a call state when pilot strength reported by the first terminal in the call state is smaller than a preset threshold value; and

sending, according to the prompt signaling, to the peer end terminal in the call state, a prompt message indicating that a pilot signal state of the first terminal is poor, where

preferably, the prompt message is a voice prompt message and/or a text prompt message.

A base station controller includes:

a pilot strength receiving module, configured to receive pilot strength reported by a first terminal in a call state; and

a prompt signaling sending module, configured to, when the pilot strength is smaller than a preset threshold value, send prompt signaling to a mobile switching center corresponding to a peer end terminal in the call state, so that the mobile switching center corresponding to the peer end terminal sends, according to the prompt signaling, to the peer end terminal, a prompt message indicating that a pilot signal state of the first terminal is poor.

A mobile switching center includes:

a prompt signaling receiving module, configured to receive prompt signaling, where the prompt signaling is sent by a base station controller corresponding to a first terminal to a mobile switching center corresponding to a peer end terminal in a call state when pilot strength reported by the first terminal in the call state is smaller than a preset threshold value; and

a prompt message sending module, configured to send, according to the prompt signaling, to the peer end terminal in the call state, a prompt message indicating that a pilot signal state of the first terminal is poor.

It can be seen from the foregoing technical solutions that, in the pilot signal state prompting method disclosed by the embodiments of the present invention, a base station controller detects pilot strength reported by a first terminal, and when the pilot strength is smaller than a preset threshold value, sends prompt signaling to a mobile switching center corresponding to a peer end terminal, so that the switching center sends a prompt message to the peer end terminal according to the prompt signaling. In this way, the peer end terminal may timely obtain a pilot signal state of the first terminal, thereby ensuring call quality and improving user experience.

### BRIEF DESCRIPTION OF DRAWINGS

To illustrate the technical solutions in the embodiments of the present invention or in the prior art more clearly, the following briefly introduces accompanying drawings required for describing the embodiments or the prior art. Apparently, the accompanying drawings in the following description show merely some embodiments of the present invention, and a person of ordinary skill in the art may still derive other drawings according to these accompanying drawings without creative efforts.

FIG. 1 is a structural diagram of a communication network topology;

FIG. 2 is a flowchart of a pilot signal state prompting method according to an embodiment of the present invention;

FIG. 3 is a flowchart of another pilot signal state prompting method according to an embodiment of the present invention;

FIG. 4 is a flowchart of another pilot signal state prompting method according to an embodiment of the present invention;

FIG. 5 is a schematic structural diagram of a base station controller according to an embodiment of the present invention; and

FIG. 6 is a schematic structural diagram of a mobile switching center according to an embodiment of the present invention.

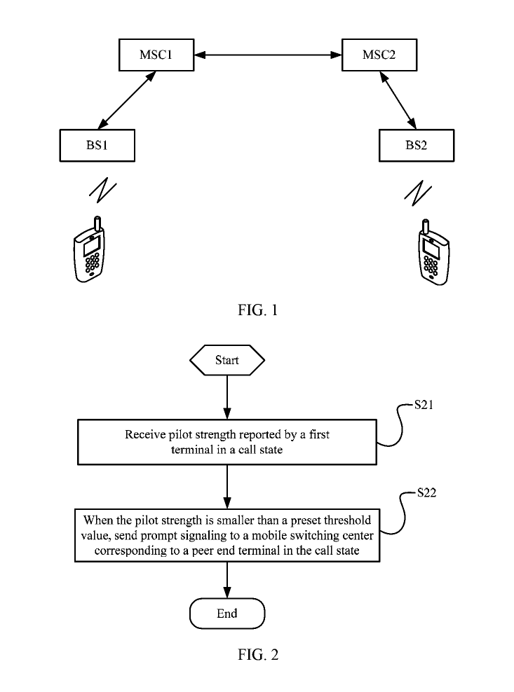

### DESCRIPTION OF EMBODIMENTS

The following clearly describes the technical solutions in the embodiments of the present invention with reference to the accompanying drawings in the embodiments of the present invention. Apparently, the embodiments to be described are merely a part rather than all of the embodiments of the present invention. All other embodiments obtained by a person of ordinary skill in the art based on the embodiments of the present invention without creative efforts shall fall within the protection scope of the present invention.

An embodiment of the present invention discloses a pilot signal state prompting method, which is applied to a CDMA network, and may achieve a purpose that a peer end terminal may learn it timely in a case that signal quality of a terminal is poor during a calling process, thereby improving user experience.

A flowchart of a pilot signal state prompting method disclosed by an embodiment of the present invention is as shown in FIG. 2, where the method includes:

Step S21: Receive pilot strength reported by a first terminal in a call state.

Step S22: When the pilot strength is smaller than a preset threshold value, send prompt signaling to a mobile switching center corresponding to a peer end terminal in the call state, so that the mobile switching center corresponding to the peer end terminal sends, according to the prompt signaling, to the peer end terminal, a prompt message indicating that a pilot signal state of the first terminal is poor.

Further, when the pilot strength is not smaller than the preset threshold value, no operation is performed.

Further, when terminals of two calling parties are in a same mobile switching center, a process of sending the prompt signaling to the mobile switching center corresponding to the peer end terminal in the call state is: A base station controller sends the prompt signaling to the mobile switching center corresponding to the first terminal and the peer end terminal, so as to send the prompt message to the peer end terminal through the mobile switching center.

However, when the terminals of the two calling parties are in different mobile switching centers, the process of sending the prompt signaling to the mobile switching center corresponding to the peer end terminal in the call state includes:

sending the prompt signaling to a mobile switching center corresponding to the first terminal; and

sending, by the mobile switching center corresponding to the first terminal, the prompt signaling to the mobile switching center corresponding to the peer end terminal.

Finally, send a prompt message to the peer end terminal through the mobile switching center corresponding to the peer end terminal, where the prompt message may be a voice prompt message, that is, the mobile switching center corresponding to the peer end terminal sends a voice message to the peer end terminal, and main content of the voice message is that the pilot signal state of the first terminal is poor, for example, “Friendly Reminder: The signal of the user you are calling is poor, and a call exception may occur.” Or, a text message is sent to the peer end terminal, such as a short message, and main content of the short message is that the pilot signal state of the first terminal is poor. Taking an actual application scenario into consideration, a user usually cannot timely check a received short message during a call. Therefore, by adopting a manner of sending a short message, it is likely that a user of the peer end terminal can learn, only after a call is ended, that the pilot signal state of the first terminal is poor, and its timeliness is worse as compared with a voice prompt manner. Likewise, a manner of simultaneously sending a voice prompt message and a text message may also be adopted. Besides the short message, the text message may also include a multimedia message or an email.

In the pilot signal state prompting method disclosed by the embodiment, a base station controller receives pilot strength reported by a first terminal and performs detection, and when the pilot strength is smaller than a preset threshold value, sends prompt signaling to a mobile switching center corresponding to a peer end terminal, so that the mobile switching center sends a prompt message to the peer end terminal according to the prompt signaling. In this way, the peer end terminal may timely obtain a pilot signal state of the first terminal and learn a reason why a normal call cannot be performed currently, thereby ensuring call quality and improving user experience.

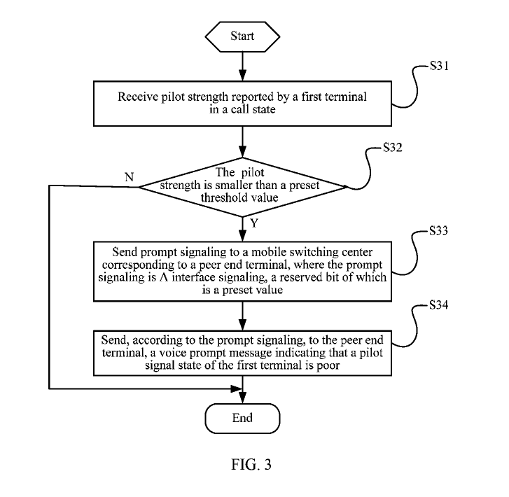

A flowchart of another pilot signal state prompting method disclosed by an embodiment of the present invention is as shown in FIG. 3, where the method includes:

Step S31: A base station controller receives pilot strength reported by a first terminal in a call state.

Step S32: Determine whether the pilot strength is smaller than a preset threshold value, and if yes, perform step S33; if no, end.

The preset threshold value MIN PILOT in the embodiment is −28 dbm and may also be −30 dbm or another value dynamically set according to an actual network condition.

Step S33: Send prompt signaling to a mobile switching center corresponding to a peer end terminal, where the prompt signaling is A interface signaling, a reserved bit of which is a preset value.

In the embodiment, a manner of assigning the preset value to the reserved bit of the A interface signaling according to a preset rule may be adopted to obtain the prompt signaling. A specific assignment manner may be: setting the reserved bit of the A interface signaling between the base station controller and the mobile switching center to 1.

In the embodiment, by extending the A interface signaling applied between the base station controller and the mobile switching center, the prompt signaling is sent by using the extended A interface signaling. Generally speaking, extension is to endow a bit with a reserved bit in an original rule with a new function. Therefore, a general extension manner is using an idle bit or multiplexing a bit with another function. In the embodiment, a manner of setting an idle bit is adopted, and all reserved idle bits are set to 1 according to the preset rule, indicating that the currently sent signaling is the prompt signaling.

Step S34: The mobile switching center corresponding to the peer end terminal sends, according to the prompt signaling, to the peer end terminal, a voice prompt message indicating that a pilot signal state of the first terminal is poor.

In the embodiment, it is not limited to adopt the manner of setting all reserved idle bits to 1 to perform signaling extension. A specific extension solution may be set according to different situations, for example, setting a specific reserved bits to 1, as long as it is ensured that the mobile switching center corresponding to the peer end terminal can identify the extended signaling as the prompt signaling.

In the pilot signal state prompting method disclosed by the embodiment, signaling between a base station controller and a mobile switching center is extended to obtain prompt signaling, so that in this method, existing signaling is used as a carrier and an existing signaling transmission mode is used to implement transmission of the prompt signaling, which is simple to operate and easy to implement.

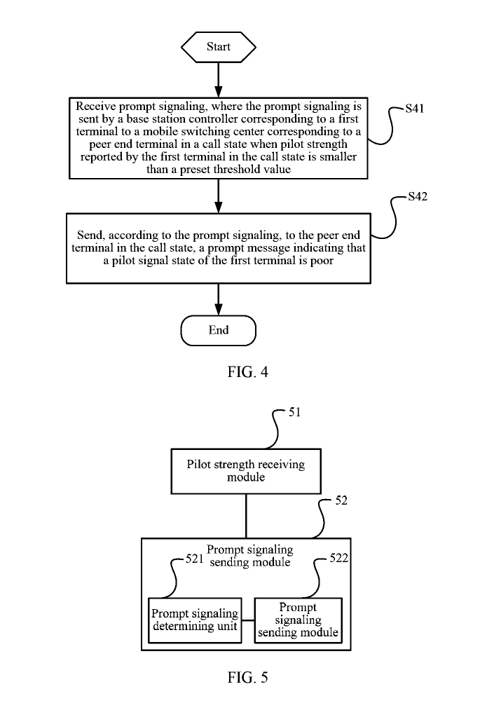

A flowchart of another pilot signal state prompting method simultaneously disclosed by an embodiment of the present invention is as shown in FIG. 4, where the method includes:

Step S41: Receive prompt signaling, where the prompt signaling is sent by a base station controller corresponding to a first terminal to a mobile switching center corresponding to a peer end terminal in a call state when pilot strength reported by the first terminal in the call state is smaller than a preset threshold value.

Step S42: Send, according to the prompt signaling, to the peer end terminal in the call state, a prompt message indicating that a pilot signal state of the first terminal is poor.

The method disclosed by the embodiment is applied to a mobile switching center corresponding to the first terminal, and corresponds to the method shown in FIG. 2 or FIG. 3, and finally achieves a purpose of sending the prompt message to the peer end terminal so that the peer end terminal can timely obtain the pilot signal state of the first terminal. When terminals of two calling parties are at a same mobile switching center, the method is also applied to the mobile switching center corresponding to both the first terminal and the peer end terminal.

The prompt message in the embodiment may be a voice prompt message, a text prompt message, or a voice prompt message and a text prompt message that are simultaneously sent. Besides a short message, the text prompt message may also include a multimedia message or an email. Content of the voice prompt message and the text prompt message is not limited. Content that can enable the peer end terminal to learn the pilot signal state of the first terminal falls in the protection scope of the embodiment.

The present invention simultaneously discloses a base station controller, a structure of which is as shown in FIG. 5, including: a pilot strength receiving module 51 and a prompt signaling sending module 52, where

the pilot strength receiving module 51 is configured to receive pilot strength reported by a first terminal in a call state; and the prompt signaling sending module 52 is configured to, when the pilot strength is smaller than a preset threshold value, send prompt signaling to a mobile switching center corresponding to a peer end terminal in the call state, so that the mobile switching center corresponding to the peer end terminal send, according to the prompt signaling, to the peer end terminal, a prompt message indicating that a pilot signal state of the first terminal is poor. The prompt signaling is A interface signaling, a reserved bit of which is a preset value. A method for assigning the preset value to the reserved bit of the A interface signaling is the same as that in the foregoing embodiment, and is not described in detail herein again.

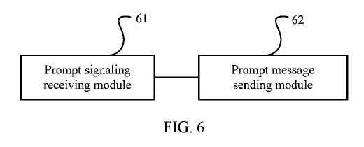

The present invention simultaneously discloses a mobile switching center, a structure of which is as shown in FIG. 6, including: a prompt signaling receiving module 61 and a prompt message sending module 62, where

the prompt signaling receiving module 61 is configured to receive prompt signaling, where the prompt signaling is sent by a base station controller corresponding to a first terminal to a mobile switching center corresponding to a peer end terminal in a call state when pilot strength reported by the first terminal in the call state is smaller than a preset threshold value; and the prompt message sending module 62 is configured to send, according to the prompt signaling, to the peer end terminal in the call state, a prompt message indicating that a pilot signal state of the first terminal is poor.

The mobile switching center disclosed by the embodiment coordinately works with the base station controller shown in FIG. 5. The base station controller receives pilot strength sent by a first terminal during a calling process, and when it is determined that the pilot strength is smaller than a preset threshold value, sends prompt signaling to a mobile switching center corresponding to a peer end terminal in a call state, and after receiving the prompt signaling, the mobile switching center sends, according to the prompt signaling, to the peer end terminal, a prompt message indicating that a pilot signal state of the first terminal is poor, so that the peer end terminal can timely obtain the pilot signal state of the first terminal during the calling process and learn a reason why a normal call cannot be performed currently, thereby improving user experience.

All the embodiments in this specification are described in a progressive manner. Each embodiment emphasizes a difference from other embodiments. For same and similar parts among all the embodiments, reference may be made to each other. The apparatuses disclosed in the embodiments correspond to the methods disclosed in the embodiments, and therefore, are simply described. For a related part, reference may be made to the description in the method embodiments.

A person skilled in the art may be further aware that the units and algorithm steps of each example described in combination with the embodiments disclosed in this specification can be implemented by electronic hardware, computer software, or a combination of the two. To clearly describe interchangeability of the hardware and software, the composition and steps of each example are generally described according to functions in the preceding description. Whether the functions are performed in a hardware or software manner depends on particular applications and design constraint conditions of the technical solutions. A person skilled in the art may use different methods to implement the described functions for each particular application, but it should not be considered that the implementation goes beyond the scope of the present invention.

The methods or algorithm steps described in combination with the embodiments disclosed in this specification may be implemented by directly using hardware or a software module executed by a processor, or a combination of the two. The software module may be disposed in a random access memory (RAM), a memory, a read only memory (ROM), an electrically programmable ROM, an electrically erasable programmable ROM, a register, a hard disk, a removable disk, a CD-ROM, or any other storage media well-known in the art.

The preceding description of the disclosed embodiments enables a person skilled in the art to implement or use the present invention. A plurality of modifications to these embodiments are apparent for a person skilled in the art. A general principle defined in the present invention may be implemented in other embodiments without departing from the spirit or scope of the present invention. Therefore, the present invention will not be limited to the embodiments described in the specification but extends to a widest scope that complies with the principle and novelty disclosed in the specification.

1. A pilot signal state prompting method, comprising:
receiving pilot strength reported by a first terminal in a call state; and
when the pilot strength is smaller than a preset threshold value, sending prompt signaling to a mobile switching center corresponding to a peer end terminal in the call state, and sending, by the mobile switching center corresponding to the peer end terminal, according to the prompt signaling, to the peer end terminal, a prompt message indicating that a pilot signal state of the first terminal is poor.

2. The method according to claim 1, wherein when a mobile switching center corresponding to the first terminal and the mobile switching center corresponding to the peer end terminal are the same, a process of sending the prompt signaling to the mobile switching center corresponding to the peer end terminal in the call state comprises:
sending the prompt signaling to the mobile switching center corresponding to the first terminal and the peer end terminal.

3. The method according to claim 1, wherein when a mobile switching center corresponding to the first terminal and the mobile switching center corresponding to the peer end terminal are different, a process of sending the prompt signaling to the mobile switching center corresponding to the peer end terminal in the call state comprises:
sending the prompt signaling to the mobile switching center corresponding to the first terminal; and
sending, by the mobile switching center corresponding to the first terminal, the prompt signaling to the mobile switching center corresponding to the peer end terminal.

4. The method according to claim 1, wherein the prompt signaling is A interface signaling, a reserved bit of which is a preset value.

5. The method according to claim 2, wherein the prompt signaling is A interface signaling, a reserved bit of which is a preset value.

6. The method according to claim 3, wherein the prompt signaling is A interface signaling, a reserved bit of which is a preset value.

7. A pilot signal state prompting method, comprising:
receiving prompt signaling, wherein the prompt signaling is sent by a base station controller corresponding to a first terminal to a mobile switching center corresponding to a peer end terminal in a call state when pilot strength reported by the first terminal in the call state is smaller than the preset threshold value; and
sending, according to the prompt signaling, to the peer end terminal in the call state, a prompt message indicating that a pilot signal state of the first terminal is poor.

8. The method according to claim 7, wherein the prompt message is a voice prompt message.

9. The method according to claim 7, wherein the prompt message is a text prompt message.

10. The method according to claim 7, wherein the prompt message comprises a voice prompt message [[a ]]and a text prompt message.

11. The method according to claim 7, wherein the prompt signaling is A interface signaling, a reserved bit of which is a preset value.

12. The method according to claim 8, wherein the prompt signaling is A interface signaling, a reserved bit of which is a preset value.

13. The method according to claim 9, wherein the prompt signaling is A interface signaling, a reserved bit of which is a preset value.

14. The method according to claim 10, wherein the prompt signaling is A interface signaling, a reserved bit of which is a preset value.

15. A base station controller, comprising:
a pilot strength receiving module, configured to receive pilot strength reported by a first terminal in a call state; and
a prompt signaling sending module, configured to, when the pilot strength is smaller than a preset threshold value, send prompt signaling to a mobile switching center corresponding to a peer end terminal in the call state, so that the mobile switching center corresponding to the peer end terminal sends, according to the prompt signaling, to the peer end terminal, a prompt message indicating that a pilot signal state of the first terminal is poor.

16. The base station controller according to claim 15, wherein the prompt signaling is A interface signaling, a reserved bit of which is a preset value.

17. A mobile switching center, comprising:
a prompt signaling receiving module, configured to receive prompt signaling, wherein the prompt signaling is sent by a base station controller corresponding to a first terminal to a mobile switching center corresponding to a peer end terminal in a call state when pilot strength reported by the first terminal in the call state is smaller than a preset threshold value; and
a prompt message sending module, configured to send, according to the prompt signaling, to the peer end terminal in the call state, a prompt message indicating that a pilot signal state of the first terminal is poor.
